(19) United States
(12) Patent Application Publication
(10) Pub. No.: US 2009/0041223 A1
(43) Pub. Date: Feb. 12, 2009

(54) Systems, methods, and computer readable media for triggerless call redirection with release

(76) Inventors: Devesh Agarwal, Raleigh, NC (US); Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/228,249

(22) Filed: Aug. 11, 2008

Related U.S. Application Data
(60) Provisional application No. 60/964,367, filed on Aug. 10, 2007.

(51) Int. Cl. H04M 3/42

(52) U.S. Cl. 379/211.02

(57) ABSTRACT

Systems, methods, and computer readable media for triggerless call redirection with release are disclosed. According to one aspect, the subject matter described herein includes a method for providing triggerless call redirection with release. The method includes, at a communications node in a telecommunications network, intercepting a call setup signaling message that is associated with a call for which a first circuit-switched bearer path has been reserved and that contains information identifying a subscriber. The information identifying the subscriber is used to determine whether call redirection information (call offloading information, switching office cutover information, and/or advanced routing information) exists for the subscriber. If call redirection information exists for the subscriber, a release message for releasing the first circuit-switched bearer path and selecting a second bearer path based on the call redirection information associated with the subscriber is sent.

### PRIORITY CLAIM

This application claims the benefit of U.S. Provisional Patent Application Ser. No. 60/964,367, filed Aug. 10, 2007; the disclosure of which is incorporated herein by reference in its entirety.

### TECHNICAL FIELD

The subject matter described herein relates to systems and methods for routing calls through a telecommunications network. More particularly, the subject matter described herein relates to systems, methods, and computer readable media for triggerless call redirection with release.

### BACKGROUND

Telephone number portability was mandated in the United States by the Telecommunications Act of 1996, which allows telephone service subscribers to retain their same directory numbers, i.e., their telephone numbers, when changing service providers or service locations. Historically, a subscriber's telephone number identified the physical circuit or line that was connected to the customer's premises, one of many circuits or lines handled by a telephone switch. This physical circuit is also referred to as a switching port. The telephone switch, also referred to as a switching office, a central office, or local exchange, is hereinafter referred to generically as a switching point, or SP. Thus, a local telephone number “XXX-YYYY” indicated that the line, referred to as the local loop, that connected the SP to the customer's premises was connected to switching port “YYYY” on switch “XXX”. When a subscriber changed locations and/or service providers, the subscriber's telephone number was also changed, representing a change from one switching port to another switching port, either in the same SP or a different SP. Since the telephone number of a called party corresponded to the physical circuit connecting the SP to the called party's premises, the telephone number itself was essentially the network address of the called party. For example, calling party A dials the telephone number of called party B, which is “1234567”. The switch connected to calling party A's phone routes the call to local exchange 123; once the call reaches local exchange 123, the exchange routes the call to its own switching port 4567, which is physically connected to the local loop for called party B.

With the advent of modern telecommunications systems, an additional layer of abstraction was created to map the subscriber's telephone number to the SP. This abstraction is implemented as a location routing number (LRN), which is a 10-digit number that identifies a switching port in an SP. Thus, when a subscriber's local service is moved to another service provider, such as to another SP, the ported directory number of the subscriber is associated with the LRN of the ported-to switching office in a number portability (NP) database, which in the United States is administered by the Number Portability Administration Center (NPAC). The NPAC distributes number portability data to service provider via local service management systems (LSMSs). The LSMS of each service provider is used to provision the service provider's number portability database. When a subscriber is moved from a first switching point to a second switching point while keeping the same directory number, the first switching point is referred to as the “donor SP” and the second switching point is referred to as the “recipient SP”. The subscriber is referred to as a “ported” subscriber.

Number portability is but one mechanism by which a call may be redirected from a donor SP to a recipient SP. Other mechanisms include call offloading, switching office cutover, and advanced routing number. Call offloading, or CO, redirects calls from SS7-based networks, such as PSTN, 2G, Wireless, GSM, IS41, etc., to non-SS7-based networks, such as networks based on Internet protocol (IP) multimedia subsystem (IMS), next generation network (NGN), session initiation protocol (SIP), H.323, and others. Switching office cutover, or CTO, is the process by which subscribers are migrated from one switching point to another, such as when an old central office is replaced with a new facility. In this case, the subscriber may otherwise have no change in service, telephone number, location, or service plan. Advanced routing number, or ARN, allows a call to be redirected to another number based on a variety of parameters, including time of day (so that a call may “follow the sun”, e.g., be routed to an east-coast office in the morning, to a west-coast office in the evening, to an overseas office at night, etc.), geographic location of the caller (so that a caller on the east coast is connected to the east coast office while a caller on the west coast is connected to the west coast office, for example), emergency or disaster routing, and others.

When a call is made to a ported subscriber, the originating SP may have a software-implemented mechanism, referred to as a trigger, which detects that the call should be redirected, and the SP may take action to determine how to redirect the call. For example, detection that the called party directory number is ported may trigger a query to call redirection database. The call redirection database may return call redirection information, such as the network address of the recipient SP, which the originating SP uses to route the call to the recipient SP.

However, legacy switching points may not yet include the capability to detect that the called party directory number requires redirection, generate a trigger, and query a call redirection database. Some telecommunications networks include many legacy switching points that do not support call redirection triggers. Updating each legacy switch in such networks to support call redirection triggers would be time, labor, and cost intensive.

Furthermore, when a call originates from a switching point that does not support call redirection, the originating SP will simply connect the call to the presumed destination SP via a first trunk connecting the originating SP to the presumed destination SP. If the presumed destination SP is able to perform call redirection processing, the presumed destination SP may determine the actual destination SP and connect the call to the actual destination SP via a second trunk connecting the presumed destination SP to the actual destination SP. Thus, although it is not necessary that the originating SP be capable of call redirection processing, so long as the presumed destination SP is capable of call redirection processing, this results in a connection to the ported called party using two trunks—one from originating SP to presumed destination SP and another from presumed destination SP to actual destination SP—instead of one trunk from originating SP to actual destination SP, resulting in inefficient use of trunk resources.

In order to alleviate some of these problems, methods for triggerless call redirection have been developed. Triggerless call redirection enables a call redirection lookup to be performed based on a call setup signaling message without requiring an originating end office call redirection trigger. However, conventional triggerless call redirection suffers from one or more disadvantages, such as inefficient trunk utilization as described above. Furthermore, packet-based networks are also susceptible to inefficient use of network resources caused by unnecessary routing from an originating node, through a donor node, through to a recipient node. In addition, conventional triggerless call redirection methods are believed to be limited to number portability applications and are not believed to have been applied to advanced routing, cutover, or call offloading applications.

Accordingly, in light of these difficulties, there exists a need for systems, methods, and computer readable media for triggerless call redirection with release.

### SUMMARY

According to one aspect, the subject matter described herein includes a method for providing triggerless call redirection with release. The method includes, at a communications node in a telecommunications network, intercepting a call setup signaling message that is associated with a call for which a first circuit-switched bearer path has been reserved and that contains information identifying a subscriber. The information identifying the subscriber is used to determine whether call redirection information (call offloading information, switching office cutover information, and/or advanced routing information) exists for the subscriber. If call redirection information exists for the subscriber, a release message for releasing the first circuit-switched bearer path and selecting a second bearer path based on the call redirection information associated with the subscriber is sent. As used herein, the term “triggerless” as applied to a function or module for performing a process means that an end office trigger is not required to initiate the performance of the process.

According to another aspect, the subject matter described herein includes a method for providing triggerless call redirection with release. The method includes, at a communications node in a network having a circuit-switched portion and a packet-switched portion, intercepting a call setup signaling message that is associated with a call for which a first circuit-switched bearer path has been reserved, the message containing information identifying a subscriber. The information identifying the subscriber is used to determine whether call redirection information exists for the subscriber. If call redirection information exists for the subscriber, a release message for releasing the first circuit-switched bearer path and selecting a second bearer path based on the redirection information associated with the subscriber is sent.

According to another aspect, the subject matter described herein includes a system for providing triggerless call redirection with release. The system includes a communications node in a telecommunications network for intercepting a call setup signaling message that is associated with a call for which a first circuit-switched bearer path has been reserved, and contains information identifying a subscriber. The system also includes a triggerless call redirection module, operatively associated with the communications node, for determining, using the information identifying the subscriber, whether call redirection information exists for the subscriber, wherein the call redirection information comprises one of call offloading information, switching office cutover information, and advanced routing information, and, in response to determining that the call redirection information exists, sending a release message for releasing the first circuit-switched bearer path and selecting a second bearer path based on the call redirection information associated with the subscriber.

As used herein, the term “operatively associated” as applied to two entities means that the entities communicate with each other. The two entities may be physically co-located (e.g., physically on the same platform) or may be physically separate from each other (e.g., on physically separate platforms and/or in physically separate geographic locations.)

According to another aspect, the subject matter described herein includes a system for providing triggerless call redirection with release. The system includes a communications node in a network having a circuit-switched portion and a packet-switched portion, for intercepting a call setup signaling message that is associated with a call for which a first circuit-switched bearer path has been reserved, the message containing information identifying a subscriber. The system also includes a triggerless call redirection module, operatively associated with the communications node, for determining, using the information identifying the subscriber, whether call redirection information exists for the subscriber, and, in response to determining that the call redirection information exists, sending a release message for releasing the first circuit-switched bearer path and selecting a second bearer path based on the redirection information associated with the subscriber.

The subject matter described herein for triggerless call redirection with release may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer perform steps.

Exemplary computer readable media suitable for implementing the subject matter described herein include disk memory devices, chip memory devices, programmable logic devices, and application specific integrated circuits. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram illustrating an exemplary system for providing triggerless call redirection with release according to an embodiment of the subject matter described herein;

FIG. 2 is a flow chart illustrating an exemplary process for performing triggerless call redirection with release according to an embodiment of the subject matter described herein;

FIG. 3 is a block diagram illustrating an exemplary system for providing triggerless call redirection with release according to another embodiment of the subject matter described herein;

FIG. 4 is a block diagram illustrating an exemplary system for providing triggerless call redirection with release according to another embodiment of the subject matter described herein;

FIG. 5 is a block diagram illustrating an exemplary system for providing triggerless call redirection with release according to another embodiment of the subject matter described herein;

FIG. 6 is a block diagram illustrating an exemplary system for providing triggerless call redirection with release according to another embodiment of the subject matter described herein;

FIG. 7 is a flow chart illustrating an exemplary process for performing triggerless call redirection with release according to an embodiment of the subject matter described herein;

FIG. 8 is a block diagram illustrating an exemplary system for providing triggerless call redirection with release according to another embodiment of the subject matter described herein; and

FIG. 9 is a block diagram illustrating an exemplary communication node for providing triggerless call redirection with release according to another embodiment of the subject matter described herein.

### DETAILED DESCRIPTION

In accordance with the subject matter disclosed herein, systems, methods, and computer program products are provided for triggerless call redirection with release.

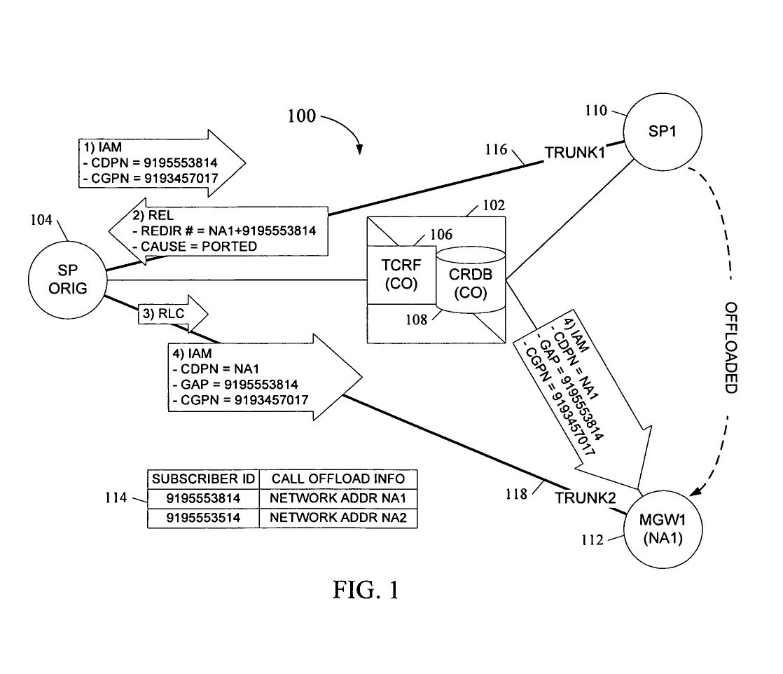

FIG. 1 is a block diagram illustrating an exemplary system for providing triggerless call redirection with release according to an embodiment of the subject matter described herein. System 100 may be a telecommunications network that includes a communications node 102 for intercepting a call setup signaling message, sent from switching point 104, that is associated with a call for which a first circuit-switched bearer path has been reserved and that includes information identifying a subscriber. System 100 also includes a triggerless call redirection module (TCRM) 106, operatively associated with communications node 102, for determining, using the information identifying the subscriber, whether call redirection information exists for the subscriber. If call redirection information does exist for the subscriber, TCRM 106 sends a release message for releasing the first circuit-switched bearer path and selecting a second bearer path based on the call redirection information associated with the subscriber. The call redirection information may be call offloading (CO) information, switching office cutover (CTO) information, or advanced routing (ARN) information. The second bearer path selected may be another circuit-switched bearer path, or it may be a packet-switched bearer path.

In an circuit-switched network, communications node 102 may be an signaling message routing node, such as a signal transfer point (STP), a service control point (SCP), or an application server (AS). In a network having both a circuit-switched (CS) portion and a packet-switched (PS) portion, herein referred to as a “merged” network, communications node 102 may also be an entity within the PS network, such as a session initiation protocol (SIP) server, an Internet protocol (IP) multimedia subsystem (IMS) node, or other node that is involved with the processing of signaling messages.

Communications node 102 may intercept call setup signal messages by identifying call setup signaling messages of a predetermined type or types that are not addressed to communications node 102 and that are candidates for redirection. For example, communications node 102 may identify ISDN user part (ISUP) initial address messages (IAMs), ISUP subsequent address messages (SAMs), or SIP invite messages that are addressed to switching offices as redirection candidates and perform additional redirection-related processing for such messages.

Switching point 104 may directly or indirectly control the reservation and release of circuit-switched bearer paths. In an SS7-only network, switching point 104 may be a service switching point (SSP), a mobile switching center (MSC), a public switched telephone network (PSTN) end office, or other source of signaling messages. In a merged network, call setup messages may also originate from a non-SS7 node, such as a node in a SIP, IMS, or NGN network, and be translated into an SS7-protocol message upon entry into the SS7 portion of the network. Thus, in the merged network, switching point 104 may be either an SS7 network node, such as an SSP or, or a packet network node, such as a call session control function (CSCF) node—depending on whether the call originated from the circuit-switched or packet-switched portion of the merged network.

Therefore, for calls that originate from the packet-switched portion of a merged network, switching point 104 may be a session initiation protocol (SIP) node, an Internet protocol multimedia subsystem (IMS) node, a next generation networking (NGN) node, or a signaling gateway (SGW). However, if communications node 102 is a node within the circuit-switched portion of the network, such as an STP, communications node 102 will send the release message to the first node that can reserve and release circuit-switched bearer paths, e.g., a media gateway controller (MGC). In this scenario, switching point 104 is the media gateway controller. Similarly, switching point 104 may be a soft switch (SS), a media gateway (MGW), a media resource function controller (MRFC), or a media resource function processor (MRFP).

The information identifying a subscriber contained in the call setup signaling message may be a calling party number, a called party number, a uniform resource identifier (URI), a session initiation protocol (SIP) address, a presence name, a subscriber ID, or other information identifying a subscriber.

In one embodiment, TCRM 106 may determine whether a call should be redirected by searching a call redirection information database CRDB 108 for maintaining redirection information using the information identifying the subscriber. For example, TCRM 106 may engage in a query/response transaction with CRDB 108, such as a call offloading lookup, a switching office cutover lookup, and an advanced routing lookup. Alternatively, TCRM 106 may perform a table lookup, access a data structure in memory, or use some other means to retrieve redirection information associated with a subscriber. In one embodiment, call redirection information database 108 may include one or more call redirection records 114 for associating a subscriber with a network address, such as a location routing number, with information identifying a network, or with routing information. The network address may be a point code/subsystem number, a URI, an IP address, or other identifier. The network address may represent a switching point (SP), such as an SSP, an MSC, an MGW, etc.

In the embodiment illustrated in FIG. 1, TCRM 106 may be adapted to triggerlessly perform redirection information lookup for determining whether the destination of a call should be redirected from a donor SP 110 to a recipient SP 112. For example, donor SP 110 may be the switch that originally handled the called party, while recipient SP 112 may be a the switch that now handles the called party. In this example, TCRM 106 would sent to switching point 104 a release message instructing switching point 104 to release the circuit-switched bearer path, trunk1 116, that had been reserved between switching point 104 and the presumed destination, donor SP 110. The release message would include information indicating to switching point 104 that trunk2 118 should be reserved, instead.

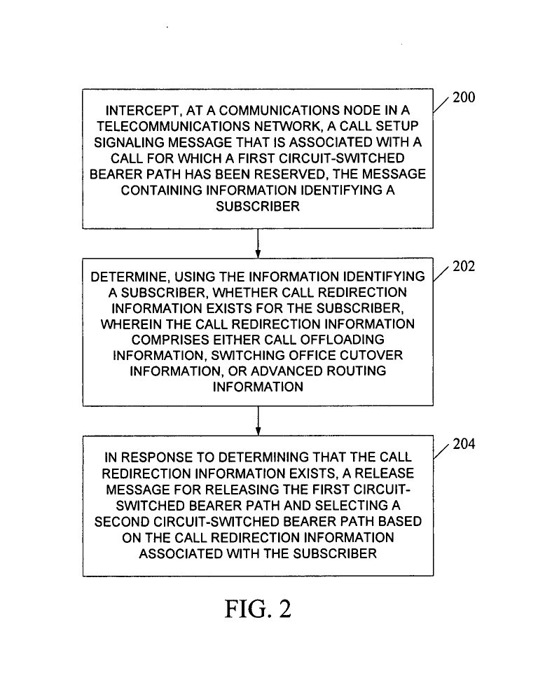

FIG. 2 is a flow chart illustrating an exemplary process for performing triggerless call redirection with release according to an embodiment of the subject matter described herein. At block 200, a call setup signaling message associated with a call for which a first circuit-switched bearer path has been reserved and containing information identifying a subscriber is intercepted at a communications node in a telecommunications network, such as a signaling message routing node. At block 202, the information identifying the subscriber is used to determine whether call redirection information exists for the subscriber that indicates that the call should be redirected. At block 204, in response to determining that redirection information exists, a release message for releasing the current bearer path and selecting a new bearer path based on the redirection information associated with the subscriber is sent. The release message may be sent to the entity that reserved the first circuit-switched bearer path, which may be a switching point, a media gateway controller, a media gateway, and in some cases a node in the packet-switched portion of a merged network. The process will now be described in more detail with reference to various embodiments illustrated in FIGS. 1, 3, 4, and 5.

FIG. 1 illustrates an embodiment which implements triggerless call offloading. The triggerless CO function may be used to offload calls from one type of network to another type of network, such as from an SS7-based network to a non-SS7-based network, without using network bearer trunk resources inefficiently and without requiring trigger upgrades for IN/AIN switching offices or other switching points. Example SS7/SIGTRAN-based networks include a public switched telephone network (PSTN), a second generation (2G) wireless network, a global system for mobile communications (GSM) network, and an interim standard 41 (IS-41) network. Example non-SS7/SIGTRAN-based networks include an IP multimedia subsystem (IMS) network, a next generation network (NGN), a session initiation protocol (SIP) network, and a H.323 network.

A call that originates within the circuit-switched network may be redirected from a congested switching point in an SS7 network, such as SP1 110, into a packet network via a media gateway MGW1 112. In this example, communications node 102, which may be an SS7 signaling message routing node, such as an STP, receives a call setup message, such as an ISUP IAM or SAM message (FIG. 1, message 1), from originating SP 104. The message includes both the calling party number (CgPN) 919.555.3814 and called party number (CdPN) 919.555.7017, respectively. Originating SP 104 may determine, based on the called party number, that the called party is likely to be serviced by donor SP 110. Based on that assumption, originating SP 104 may initiate a connection to donor SP 110 by reserving a bearer channel on Trunk1 116. In the embodiment illustrated in FIG. 1, originating SP 104 has selected an outbound trunk, identified by a circuit identification code (CIC), to the anticipated destination SP.

In response to the interception of the ISUP IAM message by communications node 102, TCRM 106 determines whether redirection information exists for a subscriber associated with the call. In one embodiment, TCRM 106 may query CRDB 108 to determine whether call redirection information exists for called party number 919.555.7017. In the embodiment illustrated in FIG. 1, CRDB 108 contains call offloading information. If the called party is targeted for call offloading, a query to CRDB 108 may return a network address identifying MGW 112 as the new destination for the call. In FIG. 1, the value of the network address for MGW 112 is represented by the string “NA1”.

In response to determining that call redirection information exists for the called party, communications node 102 may issue a release message for instructing originating SP 104 to release its current bearer channel, which in this example is on Trunk1 116. In the embodiment illustrated in FIG. 1, communication node 102 may send an ISUP release (REL) message (FIG. 1, message 2) back to originating SP 104. In one embodiment, the release message may include the network address for the new destination prepended to the called party number. For example, FIG. 1, message 2 may include the address of MGW 112, “NA1”, prepended to the called party number. The release message may also include information to indicate to originating SP 104 the reason for the redirection and release. For example, FIG. 1, message 2 may include the “Cause” parameter with a value set to “Ported”.

Upon receipt of the release message, originating SP 104 may release the bearer channel currently reserved in Trunk1 116. In one embodiment, originating SP 104 may then acknowledge the fact that the message for releasing the current bearer path has been accepted and/or that the release has been performed. For example, FIG. 1, message 3 is an ISUP release complete (RLC) message sent by originating SP 104 to communications node 102 to acknowledge that the bearer channel in Trunk1 116 has been released. Originating SP 104 may then issue a second call setup message, this time directed to recipient MGW 112. For example, FIG. 1, message 4 is an ISUP IAM message sent from originating SP 104 to recipient MGW 112, in which the original called party number is stored in the general address parameter (GAP), and the redirection information, “NA1”, is stored in the called party number parameter. Originating SP 104 may reserve a bearer channel in Trunk2 118, which connects originating SP 104 to recipient MGW 112.

This second call setup message may be received by communications node 102 on its way to recipient SP 112. In one embodiment, communications node 102 may recognize that redirection information for the called party has already been determined and thus forward the setup message to its destination without performing a redirection information lookup. For example, node 102 may assume that any call setup message with a GAP parameter containing a value is a message for which redirection information has already been determined. Alternatively, either node 102 or TCRM 106 may use another parameter, such as an NP lookup flag, to determine whether or not call redirection information lookup has been performed. Other methods of determining that call redirection has already been performed, such as the use of other parameters, other parameter values, and the like, are within the scope of the subject matter described herein.

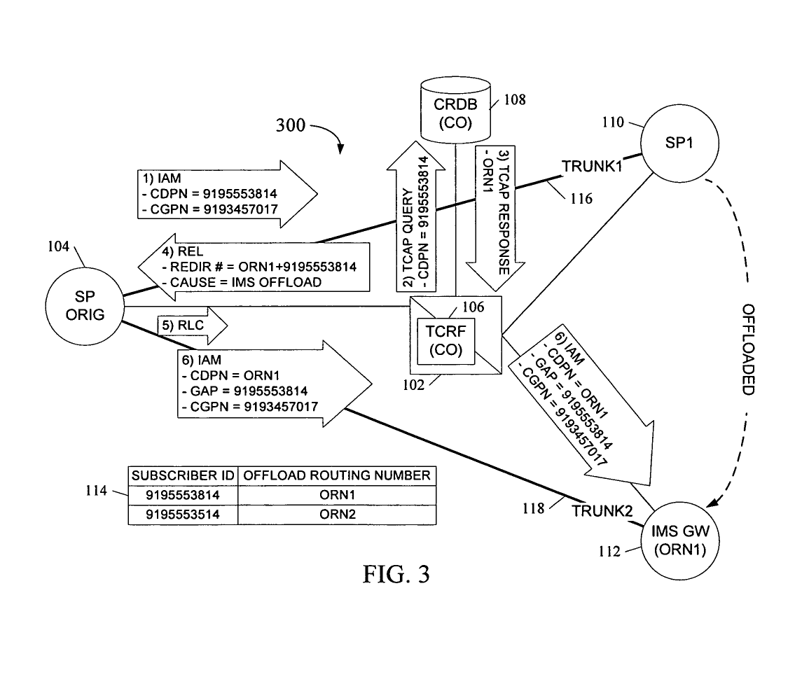

In one embodiment, the redirection information may be stored in a database that is local to TCRM 106 (i.e., co-located with TCRM 106). In an alternative embodiment, the database may be physically separate from TCRM 106 (i.e., not co-located with TCRM 106), an example of which is shown in FIG. 3.

FIG. 3 is a block diagram illustrating an exemplary system for providing triggerless call redirection with release according to another embodiment of the subject matter described herein. In one embodiment, system 300 is substantially identical to system 100 illustrated in FIG. 1, except that in the embodiment illustrated in FIG. 3, CRDB 108 is not co-located with TCRM 106. The descriptions of the like-numbered elements will therefore not be repeated herein. In FIG. 3, node 102 may intercept call setup signaling messages and TCRM 106 may query a remote call redirection database 108 to determine whether the call should be redirected. TCRM 106 receives a response from database 108 that indicates whether redirection information exists for the subscriber. If redirection information exists, the call is routed to the subscriber. If redirection information does not exist, node 102 may route the call setup signaling message to its intended destination. In one embodiment, database 108 may contain one or more call redirection records 114 for associating a subscriber ID with a location routing number (LRN).

An example operation of system 300 will now be described. In one embodiment, FIG. 3, message 1 is an ISUP IAM message containing the calling and called party numbers, stored in the CgPN and CdPN message parameters, respectively. Originating SP 104 may reserve a connection to donor SP 110 on Trunk1 116. FIG. 3, message 1 may be intercepted by node 102 and provided to TCRM 106, which may extract subscriber information, such as CgPN, CdPN, or other subscriber information that may be contained in the message.

In one embodiment, TCRM 106 may generate a query to CRDB 108 using the extracted called party subscriber information. For example, FIG. 3, message 2 is a transaction capabilities application part (TCAP) query message requesting NP information for the called party subscriber identified by called party number CdPN. In alternative embodiments, TCRM 106 may access CRDB 108 using one or more of a variety of protocols, such as any protocol, including TCAP protocol, sent over SS7 or SS7 over IP (SIGTRAN) signaling links, an Internet protocol (IP), a signaling connection control part (SCCP) user adaptation (SUA) protocol, a session initiation protocol (SIP), an extensible markup language (XML) protocol, a hypertext transfer protocol (HTTP), and a simple object access protocol (SOAP). Other protocols suitable for retrieving information indicating that the call should be redirected are within the scope of the subject matter described herein.

CRDB 108 may respond with redirection information associated with the subscriber. CRDB 108 may extract the subscriber information from the query, use the subscriber information to find a call redirection record 114 for that subscriber, retrieve the LRN associated with that subscriber, and send to TCRM 106 a query response message including the LRN associated with the subscriber. For example, FIG. 3, message 3, is a query response message that returns the called party's location routing number, “LRN1”.

Upon receipt of the redirection information from CRDB 108, TCRM 106 may send to originating SP 104 a message for releasing the current bearer path containing the call redirection information. For example, FIG. 3, message 4 is an ISUP REL message that includes a redirect number parameter for identifying a new call destination and a cause parameter for indicating the reason for the release and redirection. In FIG. 3, message 4, the redirect number parameter contains the call redirection information LRN1 prepended to called party number CdPN, and the cause parameter indicates that the release and redirection is requested because the called party subscriber has been ported. Upon receipt of the REL message, originating SP 104 may release the reserved bearer channel through Trunk1 116. Originating SP 104 may or may not acknowledge the release. In one embodiment, FIG. 3, message 5 is an ISUP release complete (RLC) message sent from originating SP 104 to communications module 302 to confirm the release of bearer channel through Trunk1 116.

In one embodiment, originating SP 104 may then send a call setup message directed toward the new call destination, recipient SP MGW 112. For example, FIG. 3, message 6 is an ISUP IAM message in which the called party parameter CdPN contains the redirection information received from CRDB 108, “LRN1”. Originating SP 104 may reserve a bearer channel in a trunk connecting originating SP 104 and MGW 112, such as Trunk2 118.

This second call setup message may be received by node 102 on its way to recipient SP 112. As described for FIG. 1, message 4, above, node 102 may recognize that redirection information for the called party has already been determined and thus forward the setup message to its destination without performing a redirection information lookup.

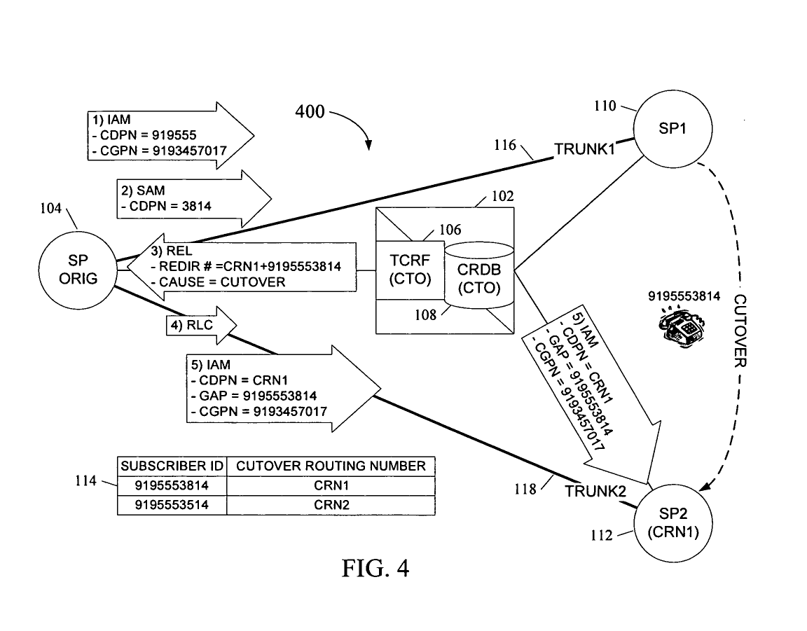

FIG. 4 is a block diagram illustrating an exemplary system for providing triggerless call redirection with release according to another embodiment of the subject matter described herein. In one embodiment, system 400 is substantially identical to system 100 illustrated in FIG. 1, except that in the embodiment illustrated in FIG. 4, communications node 102 may include a triggerless call release function TCRM 106 that is adapted to support the use of ISUP subsequent address messages (SAMs), which are used to convey additional address information not contained in the initial address message or IAM. In addition, TCRM 106 performs a triggerless switching office cutover lookup. The triggerless CTO function may be used to “cut over” or migrate subscribers from a donor switching office to recipient switching office in an SS7/SIGTRAN-based communications network, such as a PSTN, without using network bearer trunk resources inefficiently and without requiring trigger upgrades for IN/AIN switching offices or other switching points. Switching office cutover may be used to facilitate the migration of subscribers between traditional TDM/circuit switched end offices, or between TDM switching offices and packet switching offices (e.g., MGC, softswitch), or between packet switching offices. For example, donor SP 110 may be an obsolete central office whose functions and/or subscribers are being taken over by a newer, more capable recipient SP 112.

An example operation of system 400 will now be described. Originating SP 104 may send an ISUP IAM message (FIG. 4, message 1) to node 102, where the message is processed by TCRM 106. In one embodiment, TCRM 106 may determine that there is not sufficient called party subscriber information with which to perform a redirection information lookup, in which case TCRM 106 may temporarily buffer or store the IAM message and wait for additional information from originating SP 104. Meanwhile, originating SP 104 may have reserved a channel on a trunk connecting originating SP 104 to the anticipated destination donor SP 110, Trunk1 116. Later, node 102 may receive from originating SP 104 an ISUP SAM message (FIG. 4, message 2) containing additional called party subscriber address information. If TCRM 106 determines that it still does not have enough called party subscriber information, it may continue to wait for additional SAMs. Once TCRM 106 has enough information, it may proceed with a number portability query or other method to determine whether there is redirection information associated with the called party subscriber.

If TCRM 106 receives from CRDB 108 information, such as an LRN, indicating that the called party has been subject to a switching office cutover and is now served by a different end office, SP2 112, TCRM 106 may send to originating SP 104 a message including information for releasing the current bearer path and selecting a new bearer path based on the switching office cutover information associated with the subscriber (FIG. 4, message 3).

Originating SP 104 may send an acknowledgement of the release (FIG. 4, message 4), release the previously reserved connection to Trunk1 116. Originating SP 104 may then attempt to establish a call to SP 112 by sending another call setup message to SP2 112 via node 102 (FIG. 4, message 5) and reserve a channel on Trunk2 118.

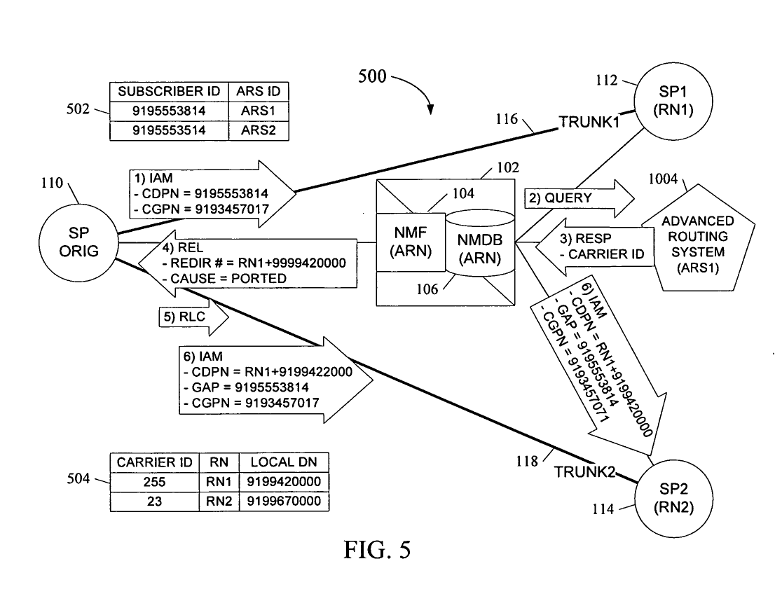

FIG. 5 is a block diagram illustrating an exemplary system for providing triggerless call redirection with release using an advanced routing number (ARN) lookup function according to another embodiment of the subject matter described herein. The triggerless ARN function allows advanced routing rules to be accessed and asserted/enforced without requiring the originating or intermediate switching offices or other switching points to support IN/AIN-based advanced routing systems, enabling a network operator to provide advanced routing services without using network bearer trunk resources inefficiently and without requiring switching office IN/AIN trigger upgrades.

In one embodiment, system 500 is substantially identical to system 100 illustrated in FIG. 1, except that in the embodiment illustrated in FIG. 5, TCRM 106 may perform an advanced routing number (ARN) lookup for redirecting a call based on parameters, such as time of day, day of week, day of year, geographic location of the caller, or other parameter used to redirect a call. For example, donor SP 110 may be the called party's business office in the eastern hemisphere and recipient SP 112 may be the called party's business office in the western hemisphere, and the lookup will direct the call to one or the other depending on which office is open at the time the call is initiated. The triggerless ARN function may be used to implementing advanced routing services (e.g., least cost routing, time of day routing, etc.) in an SS7/SIGTRAN-based communications network, such as a PSTN, without using network bearer trunk resources inefficiently and without requiring that the originating or intermediate switching points support IN/AIN-based advanced routing systems. This allows a network operator to provide advanced routing services without requiring switching office IN/AIN trigger upgrades.

In one embodiment, TCRM 106 may query CRDB 108 to determine whether a call should be redirected. TCRM 106 may receive a response from CRDB 108 indicating whether redirection information exists for the subscriber. For example, CRDB 108 may contain one or more of a first type of ARN record 502 for associating a carrier with a network routing address identifier. The carrier may be identified by a carrier identification code, for example. The network routing address may be identified by a routing number, a point code/subsystem number, an IP address, a URI, or other network entity address. For example, each ARN record 502 may associate a carrier with a routing number. CRDB 108 may contain one or more of a second type of ARN record 504 for identifying subscribers that have advanced routing service. As described above with respect to system 100, the subscriber may be identified by a subscriber ID or other identifying information, such as URI, SIP address, etc. For example, each ARN record 504 may associate a subscriber, whether the calling party or the called party, with an advanced routing system identifier (ARS ID). In alternative embodiments, TCRM 106 may perform a table lookup, access a data structure in memory, or use some other means to retrieve the advanced routing number information. According to alternative embodiments, CRDB 108, ARS 506, both, or neither may be co-located with TCRM 106. For remote databases (e.g., databases that are not co-located with TCRM 106), TCRM 106 may access the ARN information using SS7 TCAP, SIGTRAN SUA, SIP, XML, HTTP, SOAP, or any other suitable protocol.

The operation of system 500 is essentially identical to the operation of system 100, except that in the embodiment illustrated in FIG. 5, the redirection information may be associated with a subscriber and/or a carrier. For example, the redirection information associated with the subscriber may include an advanced routing system identifier (ARS ID), such as is represented by the string “ARS1” in FIG. 5, a routing number (RN) associated with a carrier, or both. An example call setup messaging flow will now be described with reference to FIG. 5.

In one embodiment, FIG. 5, message 1 is an ISUP IAM message for setting up a call between a calling party and a called party, identified by directory number contained in parameters CgPN and CdPN, respectively. TCRM 106 may search CRDB 108 to determine if a subscriber associated with the call has advanced routing service. For example, TCRM 106 may issue an ARS query (FIG. 5, message 2) and receive a response (FIG. 5, message 3) containing redirection information, “RN1”, indicating that the call should be redirected to a switching point associated with carrier ID=255. If so, TCRM 106 may issue to originating SP 104 a message including information for releasing the current bearer path and selecting a new bearer path. For example, FIG. 5, message 4, may be an ISUP REL message including a redirect number parameter containing the carrier routing number, “RN1”, prepended to the original called party directory number, and a cause parameter indicating that the redirection is due to an advanced routing service instruction. FIG. 5, message 5 may be an ISUP RLC message indicating that the bearer channel reserved in Trunk1 116 has been released. FIG. 5, message 6 may be an ISUP IAM message sent to recipient SP 112 via command module 102 requesting connection via Trunk2 118. FIG. 5, message 6 may include the carrier routing number, “RN1”, in the CdPN parameter and may store the original CdPN value in the GAP. In one embodiment, node 102 and/or TCRM 106 may support the use of ISUP SAM messages, as described in FIG. 3.

In an alternative embodiment, TCRM 106 may first query ARS 506 to get a carrier ID associated with a subscriber, then query CRDB 108 using the subscriber ID and carrier ID to determine whether the call should be redirected according to operation of an ARN rule.

TCRM 106 may then use the redirection information associated with a subscriber to query an advanced routing system ARS 506 to obtain additional ARN information. For example, TCRM 106 may send a first query to CRDB 108 to determine whether a subscriber has ARN service. If the subscriber does have ARN server, TCRM 106 may issue a second query to ARS 506 to obtain the advanced routing information. In one embodiment, TCRM 106 may query ARS 506 only for those subscribers that have been identified by CRDB 108 as having advanced routing services. In an alternative embodiment, TCRM 106 may query ARS 506 for every call setup message intercepted. It will be appreciated that advanced routing service may be provided based on either the called party subscriber identifier, the calling party subscriber identifier, or both.

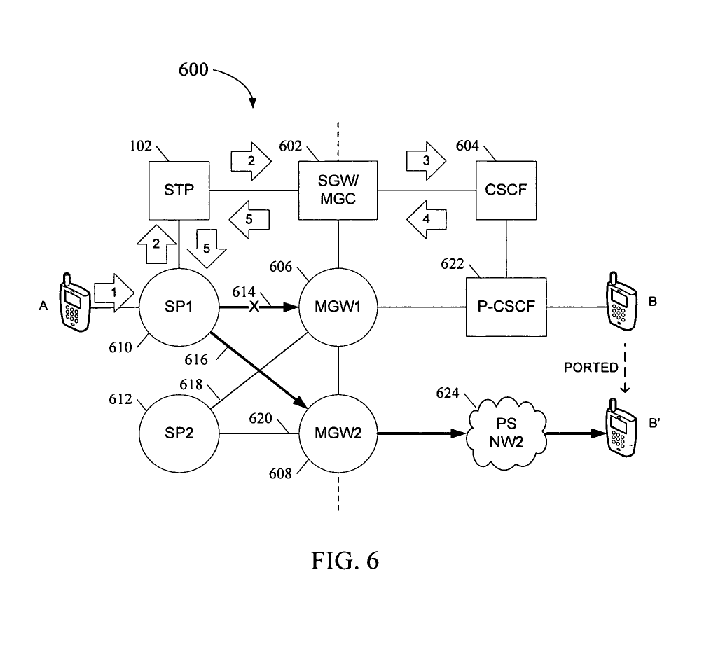

FIG. 6 is a block diagram illustrating an exemplary system for providing triggerless call redirection with release according to another embodiment of the subject matter described herein. System 600 includes a network having a circuit-switched portion, shown on the left side of FIG. 6, and a packet-switched portion, shown on the right side of FIG. 6.

System 600 includes a communications node for intercepting a call setup signaling message that is associated with a call for which a first circuit-switched bearer path has been reserved, the message containing information identifying a subscriber. In alternative embodiments, this function may be performed by a signaling message processing node within the circuit-switched portion of the network, such as STP 102, by a signaling gateway, such as SGW/MGC 602, or by a node within the packet-switched network, such as a call session control function (CSCF) node 604. This function could also be performed by a media gateway, such as MGW1 606 or MGW2 608. Example call flows will be presented in more detail below. In the embodiment illustrated in FIG. 6, CSCF 604 is the communications node that performs the

System 600 also includes a triggerless call redirection module, operatively associated with the communications node, for determining, using the information identifying the subscriber, whether call redirection information exists for the subscriber, and, in response to determining that the call redirection information exists, sending a release message for releasing the first circuit-switched bearer path and selecting a second bearer path based on the redirection information associated with the subscriber. The second bearer path that may be selected may be another circuit-switched bearer path, or it may be a packet-switched bearer path. For clarity, the triggerless call redirection module is presumed to be a component within the communications node that intercepts the call signaling message described above, and is not explicitly shown in FIG. 6. In the embodiment illustrated in FIG. 6, CSCF 604 is the communications node that performs the triggerless call redirection function.

In the embodiment illustrated in FIG. 6, the circuit-switched portion of system 600 includes two switching points SP1 610 and SP2 612. SP1 610 connects to MGW1 606 via Trunk1 614 and to MGW1 608 via Trunk2 616. SP2 612 connects to MGW1 606 via Trunk3 618 and to MGW2 608 via Trunk4 620. The packet-switched portion of system 600 also includes a second IMS routing node, P-CSCF 606. Media gateway MGW2 112 provides access to a second packet-switched network, PS NW2 608.

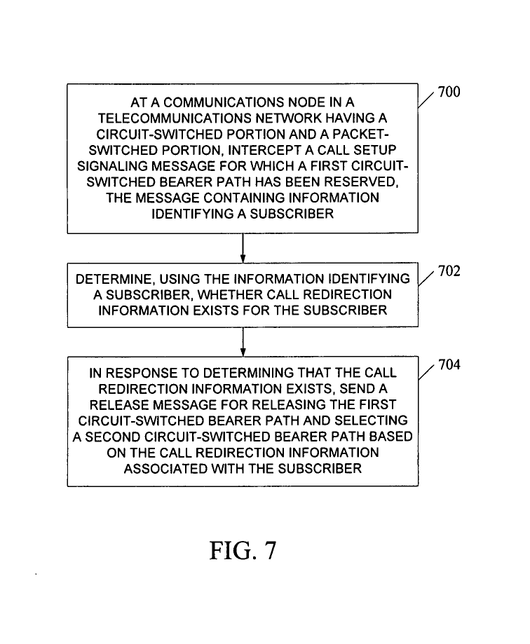

FIG. 7 is a flow chart illustrating an exemplary process for performing triggerless call redirection with release according to an embodiment of the subject matter described herein. At block 700, a call setup signaling message associated with a call for which a first circuit-switched bearer path has been reserved and containing information identifying a subscriber is intercepted at a communications node in a merged telecommunications network. In the embodiment illustrated in FIG. 6, for example, subscriber A is attempting to call subscriber B, who has been ported to a new packet-switched network, PS NW2 624. Subscriber A contacts SP1 610 (FIG. 6, message 1). SP1 610 sends an ISUP IAM message (FIG. 6, message 2) to STP 102, and also reserves a circuit-switched bearer path to MGW1 606. STP 102 forwards the message to SGW/MGC 602, which converts the ISUP IAM message to a SIP INVITE message (FIG. 6, message 3), which is forwarded to CSCF 604.

At block 702, the information identifying the subscriber is used to determine whether call redirection information exists for the subscriber. In the embodiment illustrated in FIG. 6, CSCF 604 performs the triggerless call redirection lookup, and determines that subscriber B is now serviced by PS NW2 624.

At block 704, in response to determining that call redirection information exists for the subscriber, a release message for releasing the current circuit-switched bearer path and selecting a new bearer path based on the redirection information associated with the subscriber is sent. In the embodiment illustrated in FIG. 6, CSCF 604 sends a SIP REDIRECT (3XX) message to SGW/MGC 602, which translates the message into an ISUP REL message (FIG. 6, message 5) and sends the message via STP 102 to SP1 610. In response to receiving the ISUP REL message, SP1 610 releases the reserved circuit-switched bearer path, Trunk1 614, and reserves another circuit-switched 610 bearer path, Trunk2 616, to MGW2 620.

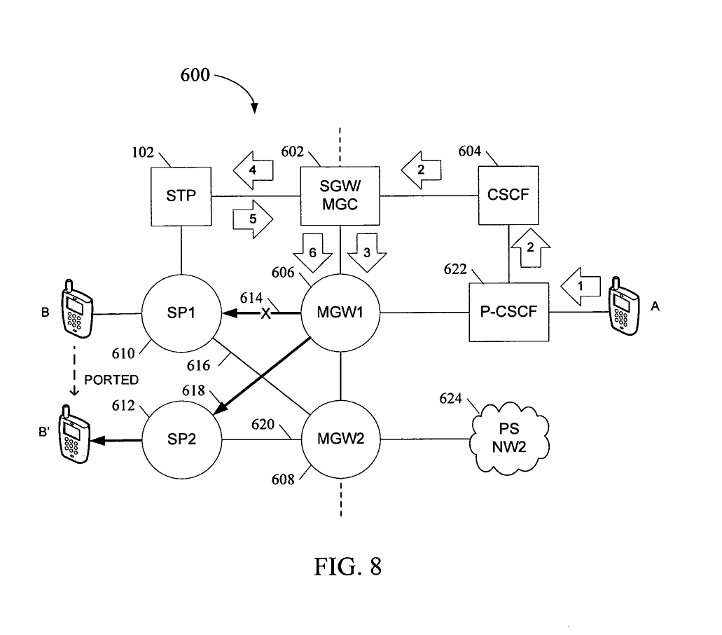

FIG. 8 is a block diagram illustrating an exemplary system for providing triggerless call redirection with release according to another embodiment of the subject matter described herein. The system of FIG. 8 is substantially identical to the system of FIG. 6, except that STP 102, instead of CSCF 604, is the communications node that performs the call redirection lookup. FIG. 8 illustrates a call originating from the packet switched network.

In the embodiment illustrated in FIG. 8, subscriber A within the packet-switched portion of the network attempts to call subscriber B (FIG. 8, message 1). P-CSCF 622 issues a SIP INVITE message (FIG. 8, message 2), which is routed through CSCF 604 to MGC 602. MGC 602 issues a media gateway control protocol command to MGW1 606 (FIG. 8, message 3), instructing MGW1 606 to reserve a circuit-switched bearer path, Trunk1 614. MGW1 606 also converts the SIP INVITE message to an ISUP IAM message (FIG. 8, message 4, which is sent towards SP1 610. STP 102 intercepts the ISUP IAM message, performs the call redirection lookup function, such as a number portability (NP) lookup, and determines that subscriber B has been ported from SP1 610 to SP2 612. In response to this determination, STP 102 sends an ISUP REL message (FIG. 8, message 5), to MGC 602. MGC 602 issues a command to MGW1 606 (FIG. 8, message 6) instructing MGW1 606 to release the reserved bearer path within Trunk1 614 and reserve a new circuit-switched bearer path within Trunk2 618. The call is then completed from SP2 612 to subscriber B.

In an alternative embodiment, the new bearer path may be a path within the packet-switched portion of the merged network. Referring again to FIG. 8, subscriber B may be ported from SP1 610 to become a subscriber serviced from within the packet-switched portion of the network. For example, subscriber B may upgrade his home telephone from a local loop within the SS7 network to a voice over IP (VoIP) digital telephone connected to the internet via a cable modem. In this scenario, MGW1 606 may release the reserved bearer path within Trunk1 614, while the call from subscriber A is rerouted to subscriber B entirely through the packet network.

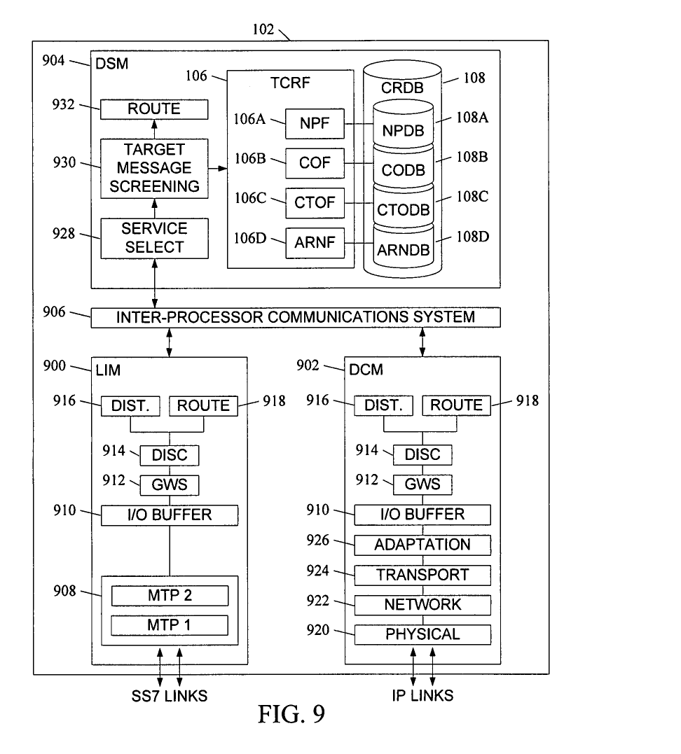

FIG. 9 is a block diagram illustrating an exemplary communications node 102 for providing triggerless call redirection with release according to another embodiment of the subject matter described herein. In one embodiment, communications node 102 may be a signal transfer point (STP). Communications node 102 includes a link interface module (LIM) 900, a data communications module (DCM) 902, and a database services module (DSM) 904. Each module 900, 902, and 904 may include a printed circuit board, an application processor for performing application level processing of signaling messages, and a communications processor for controlling inter-processor communications via inter-processor communications system 906. Inter-processor communications system 906 may be any suitable mechanism for providing message communication between processing modules 900, 902, and 904. For example, communications system 906 may be a bus, an Ethernet LAN, or any other suitable mechanism for providing communications between processors.

LIM 900 includes various functions for sending and receiving signaling messages over SS7 signaling links. In the illustrated example, LIM 900 includes a message transfer part (MTP) level 1 and 2 function 908, an I/O buffer 910, a gateway screening (GWS) function 912, a discrimination function 914, a distribution function 916, and a routing function 918. MTP level 1 and 2 function 908 performs MTP level 1 and 2 functions, such as error detection, error correction, and sequencing of signaling messages. I/O buffer 910 stores inbound signaling messages before the messages are processed by higher layers. I/O buffer 910 also stores outbound signaling messages waiting to be transmitted over a signaling link by MTP level 1 and 2 function 908. Gateway screening function 912 screens inbound signaling messages based on destination point code and, optionally, based on originating point code to determine whether the messages should be allowed into the network. Discrimination function 914 analyzes the destination point code in each received signaling message to determine whether the signaling message should be processed by an internal processing module within node 102 or whether the message should be routed over an outbound signaling link. Discrimination function 914 forwards messages that are to be internally processed to distribution function 916. Discrimination function 914 forwards messages that are to be routed over an outbound signaling link to routing function 918.

Distribution function 916 distributes messages that are identified as requiring internal processing to the appropriate internal processing module. For example, distribution function 916 may forward SCCP messages to database services module 904 for SCCP processing. Routing function 918 routes signaling messages that are addressed to point codes other than the point code of node 102. For example, routing function 918 may forward messages to another link interface module (not shown in FIG. 8) or to data communications module 902 for transmission over an outbound signaling link.

DCM 902 includes various functions for sending and receiving SS7 messages over IP signaling links. In FIG. 8, these functions include a physical layer function 920, a network layer function 922, a transport layer function 924, an adaptation layer function 926, and SS7 MTP functions 910, 912, 914, 916, and 918 as described with regard to LIM 900. Physical layer function 920 may be any suitable physical layer function for sending and receiving frames that encapsulate network layer packets. In one exemplary implementation, physical layer function 920 may be implemented using an Ethernet transceiver. Network layer function 922 may be implemented using Internet protocol, such as IPv4 or IPv6. Transport layer function 924 may be implemented using any suitable transport layer protocol. Examples of transport protocols suitable for use with embodiments of the subject matter described herein include user datagram protocol (UDP), transmission control protocol (TCP), and stream control transmission protocol (SCTP). Adaptation layer function 926 may be implemented using any suitable adaptation layer for sending SS7 messages over IP. Examples of adaptation layers suitable for use with the subject matter described herein include M3UA, M2PA, SUA, and TALI, as described in the correspondingly named IETF Internet drafts and RFCs. The remaining functions of DCM 902 are the same as those described with regard to LIM 900. Hence, a description thereof will not be repeated herein.

DSM 904 includes various functions and databases for processing signaling messages. In the illustrated example, DSM 904 includes a service selection function 928, a target message screening function 930, and a routing function 932. Database services module also includes a triggerless call redirection/release function TCRM 106 and a call redirection/release information database CRDB 108. TCRM 106 may include one or more sub-functions for performing a variety of call redirection information lookups. For example, TCRM 106 may include a number portability lookup function (NPF) 106A, a call offloading lookup function (COF) 106B, a switching office cutover lookup function (CTOF) 106C, and an advanced routing number lookup function (ARNF) 106D. Similarly, CRDB 108 may include redirection information associated with number portability (NPDB) 108A, redirection information associated with call offloading (CODB) 108B, redirection information associated with switching office cutover (CTODB) 108C, and redirection information associated with advanced routing systems (ARNDB) 108D.

Service selection function 928 receives messages from interface processors and determines the type of service required for each message. For example, service selection function 928 may determine whether further screening of messages is required or whether the messages are simply to be global title translated and routed. For CAP or INAP messages, service selection function 928 may forward the messages to target message screening function 930. Target message screening function 930 screens CAP or INAP messages received by DSM 904 to identify targeted message types. According to the subject matter described herein, target message screening function 930 may identify call setup messages, such as ISUP IAM or SAM, as a targeted message type requiring further processing. For call setup messages, targeted message screening function 930 may communicate with TCRM 106 to perform a call redirection information lookup.

TCRM 106 may perform one or more redirection information lookups. For example, one of the sub-functions 106A-106D may query respective databases 108A-108D to determine if redirection information exists for a particular subscriber (and/or carrier, in the case of an advanced routing number lookup.) The operation of these various redirection information lookup functions are the same as previously described. Hence, a description thereof will not be repeated herein. If TCRM 106 determines that redirection information exists for a subscriber, it may generate a message for releasing the current bearer path and selecting a new bearer path, and route the generated message through the inter-processor communications system 906 to the appropriate LIM or DCM according to the message destination.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for providing triggerless call redirection with release, the method comprising:
at a communications node in a telecommunications network:
intercepting a call setup signaling message that is associated with a call for which a first circuit-switched bearer path has been reserved and that contains information identifying a subscriber;
determining, using the information identifying the subscriber, whether call redirection information exists for the subscriber, wherein the call redirection information comprises one of call offloading information, switching office cutover information, and advanced routing information;
and
in response to determining that the call redirection information exists, sending a release message for releasing the first circuit-switched bearer path and selecting a second bearer path based on the call redirection information associated with the subscriber.

2. The method of claim 1 wherein the second bearer path is one of a circuit-switched bearer path and a packet-switched bearer path.

3. The method of claim 1 wherein the communications node comprises one of a signal transfer point (STP), a service control point (SCP), a session initiation protocol (SIP) node, an Internet protocol multimedia subsystem (IMS) node, a next generation networking (NGN) node, a media gateway controller (MGC), a media gateway (MGW), a signaling gateway (SGW), an interconnection border control function (IBCF) node, a breakout gateway control function (BGCF) node, a session border control (SBC) function node, a breakout gateway (BGW), a media resource function controller (MRFC), and a media resource function processor (MRFP).

4. The method of claim 1 wherein intercepting a call setup signaling message includes intercepting one of an integrated services digital network (ISDN) user part (ISUP) initial address message (IAM), an ISUP subsequent address message (SAM), and a session initiation protocol (SIP) invite signaling message.

5. The method of claim 1 wherein a source of the intercepted call setup signaling message is one of a service switching point (SSP), a mobile switching center (MSC), a public switched telephone network (PSTN) end office, a session initiation protocol (SIP) node, an Internet protocol multimedia subsystem (IMS) node, a next generation networking (NGN) node, a call session control function (CSCF) node, a media gateway controller (MGC), a media gateway (MGW), a softswitch (SS), a media resource function controller (MRFC), and a media resource function processor (MRFP).

6. The method of claim 1 wherein the information identifying the subscriber comprises at least one of information identifying a calling party and information identifying a called party.

7. The method of claim 1 wherein the information identifying the subscriber comprises at least one of a directory number, a session initiation protocol (SIP) address, a uniform resource identifier (URI), a short code, and an Internet protocol (IP) address.

8. The method of claim 1 wherein the call redirection information associated with the subscriber comprises at least one of a location routing number, information identifying a network address, information identifying a network, and routing information associated with the subscriber.

9. The method of claim 1 wherein using the information identifying the subscriber to determine whether call redirection information exists for the subscriber includes using the information identifying the subscriber to search at least one of a database, a data structure, a table, a memory location, and a data store for call redirection information associated with the subscriber.

10. The method of claim 1 wherein determining whether call redirection information exists for the subscriber includes using at least one of a transaction capabilities application part (TCAP) protocol, an Internet protocol (IP), a signaling connection and control part (SCCP) user adaptation (SUA) protocol, a session initiation protocol (SIP), an extensible markup language (XML) protocol, a hypertext transfer protocol (HTTP), and a simple object access protocol (SOAP) to access the call redirection information associated with the subscriber.

11. The method of claim 1 wherein the release message includes a redirect number parameter containing the call redirection information prepended to the information identifying the subscriber.

12. The method of claim 1 wherein the release message contains information indicating that call redirection is the cause of the release.

13. The method of claim 1 wherein the release message comprises one of an integrated services digital network (ISDN) user part (ISUP) release (REL) message and a session initiation protocol (SIP) redirection (3XX) message.

14. The method of claim 1 comprising, at a source of the call setup signaling message, receiving the release message, and, in response to receiving the release message, releasing the current bearer path and selecting a new bearer path based on the redirection information associated with the subscriber.

15. The method of claim 14 wherein selecting a new bearer path includes sending, from the source of the call setup signaling message, a second call setup signaling message for establishing a call that uses the new bearer path.

16. The method of claim 1 wherein the telecommunications network uses at least one of an Internet protocol (IP), a signaling system 7 (SS7) protocol, an SS7-over-IP protocol, a session initiation protocol (SIP), a SIP-over-IP protocol, and a bearer independent call control (BICC) protocol.

17. A method for providing triggerless call redirection with release, the method comprising:
at a communications node in a network having a circuit-switched portion and a packet-switched portion:
intercepting a call setup signaling message that is associated with a call for which a first circuit-switched bearer path has been reserved, the message containing information identifying a subscriber;
determining, using the information identifying the subscriber, whether call redirection information exists for the subscriber; and
in response to determining that the call redirection information exists, sending a release message for releasing the first circuit-switched bearer path and selecting a second bearer path based on the redirection information associated with the subscriber.

18. The method of claim 17 wherein the second bearer path is one of a circuit-switched bearer path and a packet-switched bearer path.

19. The method of claim 17 wherein determining whether call redirection information exists for the subscriber includes using at least one of a number portability (NP) lookup, a call offload (CO) lookup, a switching office cutover (CTO) lookup, and an advanced routing number (ARN) lookup to determine whether the call redirection information exists.

20. The method of claim 17 wherein the communications node comprises one of a signal transfer point (STP), a service control point (SCP), a session initiation protocol (SIP) node, an Internet protocol multimedia subsystem (IMS) node, a next generation networking (NGN) node, a media gateway control function (MGCF) node, a media gateway (MGW), a signaling gateway (SGW), an interconnection border control function (IBCF) node, a session border control (SBC) function node, a breakout gateway control function (BGCF) node, and a media resource function controller (MRFC).

21. The method of claim 17 wherein the call setup signaling message comprises one of an signaling system 7 (SS7) message, a session initiation protocol (SIP) signaling message, a SIGTRAN signaling message, an SS7-over-IP signaling message, and a bearer independent call control (BICC) protocol message.

22. The method of claim 17 wherein sending the release message comprises sending the release message to one of a service switching point (SSP), a mobile switching center (MSC), a public switched telephone network (PSTN) end office, a media gateway controller (MGC), a media gateway (MGW), a softswitch (SS), a media resource function controller (MRFC), and a media resource function processor (MRFP).

23. The method of claim 17 wherein the information identifying the subscriber comprises at least one of information identifying a calling party and information identifying a called party.

24. The method of claim 17 wherein sending a release message comprises sending at least one of an integrated services digital network (ISDN) user part (ISUP) release (REL) message and a session initiation protocol (SIP) redirection (3XX) message.

25. The method of claim 24 wherein the release message is a SIP redirection message and further comprising, at a signaling gateway, receiving the SIP redirection message, translating the SIP redirection message into an ISUP REL message, and sending the ISUP REL message.

26. The method of claim 17 wherein using the information identifying the subscriber to determine whether call redirection information exists for the subscriber includes using the information identifying the subscriber to search at least one of a database, a data structure, a table, a memory location, and a data store for call redirection information associated with the subscriber.

27. The method of claim 17 wherein the call redirection information associated with the subscriber comprises at least one of a location routing number, information identifying a network address, information identifying a network, and routing information associated with the subscriber.

28. The method of claim 17 wherein determining whether call redirection information exists for the subscriber includes using at least one of a transaction capabilities application part (TCAP) protocol, an Internet protocol (IP), a signaling connection and control part (SCCP) user adaptation (SUA) protocol, a session initiation protocol (SIP), an extensible markup language (XML) protocol, a hypertext transfer protocol (HTTP), and a simple object access protocol (SOAP) to access the call redirection information associated with the subscriber.

29. The method of claim 17 wherein the release message includes the call redirection information prepended to the information identifying the subscriber.

30. The method of claim 17 wherein the release message contains information indicating the cause of the call redirection.

31. The method of claim 17 comprising, at the source of the call setup signaling message, receiving the release message, and, in response to receiving the release message, releasing the current bearer path and selecting a new bearer path based on the redirection information associated with the subscriber.

32. The method of claim 31 wherein selecting a new bearer path includes sending, from the source of the call setup signaling message, a second call setup signaling message for establishing a call that uses the new bearer path.

33. A system for providing triggerless call redirection with release, the system comprising:
a communications node in a telecommunications network for intercepting a call setup signaling message that is associated with a call for which a first circuit-switched bearer path has been reserved and that contains information identifying a subscriber; and
a triggerless call redirection module, operatively associated with the communications node, for determining, using the information identifying the subscriber, whether call redirection information exists for the subscriber, wherein the call redirection information comprises one of call offloading information, switching office cutover information, and advanced routing information, and, in response to determining that the call redirection information exists, sending a release message for releasing the first circuit-switched bearer path and selecting a second bearer path based on the call redirection information associated with the subscriber.

34. The system of claim 33 wherein the second bearer path is one of a circuit-switched bearer path and a packet-switched bearer path.

35. The system of claim 33 wherein the communications node comprises one of a signal transfer point (STP), a service control point (SCP), a session initiation protocol (SIP) node, an Internet protocol multimedia subsystem (IMS) node, a next generation networking (NGN) node, a media gateway controller (MGC), a media gateway (MGW), a signaling gateway (SGW), an interconnection border control function (IBCF) node, a breakout gateway control function (BGCF) node, a session border control (SBC) function node, a breakout gateway (BGW), a media resource function controller (MRFC), and a media resource function processor (MRFP).

36. The system of claim 33 wherein intercepting a call setup signaling message includes intercepting one of an integrated services digital network (ISDN) user part (ISUP) initial address message (IAM), an ISUP subsequent address message (SAM), a session initiation protocol (SIP) invite signaling message, and a bearer independent call control (BICC) protocol message.

37. The system of claim 33 wherein a source of the call setup signaling message comprises one of a service switching point (SSP), a mobile switching center (MSC), a public switched telephone network (PSTN) end office, a session initiation protocol (SIP) node, an Internet protocol multimedia subsystem (IMS) node, a next generation networking (NGN) node, a call session control function (CSCF) node, a media gateway controller (MGC), a media gateway (MGW), a softswitch (SS), a media resource function controller (MRFC), and a media resource function processor (MRFP).

38. The system of claim 33 wherein the information identifying the subscriber comprises at least one of information identifying a calling party and information identifying a called party.

39. The system of claim 33 wherein the information identifying the subscriber comprises at least one of a directory number, a session initiation protocol (SIP) address, a uniform resource identifier (URI), a short code, and an Internet protocol (IP) address.

40. The system of claim 33 wherein the call redirection information associated with the subscriber comprises at least one of a location routing number, information identifying a network address, information identifying a network, and routing information associated with the subscriber.

41. The system of claim 33 wherein using the information identifying the subscriber to determine whether call redirection information exists for the subscriber includes using the information identifying the subscriber to search at least one of a database, a data structure, a table, a memory location, and a data store for call redirection information associated with the subscriber.

42. The system of claim 33 wherein determining whether call redirection information exists for the subscriber includes using at least one of a transaction capabilities application part (TCAP) protocol, an Internet protocol (IP), a signaling connection and control part (SCCP) user adaptation (SUA) protocol, a session initiation protocol (SIP), an extensible markup language (XML) protocol, a hypertext transfer protocol (HTTP), and a simple object access protocol (SOAP) to access the call redirection information associated with the subscriber.

43. The system of claim 33 wherein the release message includes a redirect number parameter containing the call redirection information prepended to the information identifying the subscriber.

44. The system of claim 33 wherein the release message contains information indicating that call redirection is the cause of the release.

45. The system of claim 33 wherein the release message comprises one of an integrated services digital network (ISDN) user part (ISUP) release (REL) message and a session initiation protocol (SIP) redirection (3XX) message.

46. The system of claim 33 comprising, at a source of the call setup signaling message, receiving the release message, and, in response to receiving the release message, releasing the current bearer path and selecting a new bearer path based on the redirection information associated with the subscriber.

47. The system of claim 33 wherein selecting a new bearer path includes sending, from the source of the call setup signaling message, a second call setup signaling message for establishing a call that uses the new bearer path.

48. The system of claim 33 wherein the telecommunications network uses at least one of an Internet protocol (IP), a signaling system 7 (SS7) protocol, an SS7-over-IP protocol, a session initiation protocol (SIP), a SIP-over-IP protocol, and a bearer independent call control (BICC) protocol.

49. A system for providing triggerless call redirection with release, the system comprising:
a communications node in a network having a circuit-switched portion and a packet-switched portion, for intercepting a call setup signaling message that is associated with a call for which a first circuit-switched bearer path has been reserved, the message containing information identifying a subscriber; and
a triggerless call redirection module, operatively associated with the communications node, for determining, using the information identifying the subscriber, whether call redirection information exists for the subscriber, and, in response to determining that the call redirection information exists, sending a release message for releasing the first circuit-switched bearer path and selecting a second bearer path based on the redirection information associated with the subscriber.

50. The system of claim 49 wherein the second bearer path is one of a circuit-switched bearer path and a packet-switched bearer path.

51. The system of claim 49 wherein determining whether call redirection information exists for the subscriber includes using at least one of a number portability (NP) lookup, a call offload (CO) lookup, a switching office cutover (CTO) lookup, and an advanced routing number (ARN) lookup to determine whether the call redirection information exists.

52. The system of claim 49 wherein the communications node comprises one of a signal transfer point (STP), a service control point (SCP), a session initiation protocol (SIP) node, an Internet protocol multimedia subsystem (IMS) node, a next generation networking (NGN) node, a media gateway control function (MGCF) node, a media gateway (MGW), a signaling gateway (SGW), an interconnection border control function (IBCF) node, a session border control (SBC) function node, a breakout gateway control function (BGCF) node, and a media resource function controller (MRFC).

53. The system of claim 49 wherein the call setup signaling message comprises one of a signaling system 7 (SS7) protocol message, a session initiation protocol (SIP) signaling message, a SIGTRAN signaling message, an SS7-over-IP signaling message, and a bearer independent call control (BICC) protocol.

54. The system of claim 17 wherein sending the release message comprises sending the release message to one of a service switching point (SSP), a mobile switching center (MSC), a public switched telephone network (PSTN) end office, a media gateway controller (MGC), a media gateway (MGW), a softswitch (SS), a media resource function controller (MRFC), and a media resource function processor (MRFP).

55. The system of claim 17 wherein the information identifying the subscriber comprises at least one of information identifying a calling party and information identifying a called party.

56. The system of claim 17 wherein sending a release message comprises sending at least one of an integrated services digital network (ISDN) user part (ISUP) release (REL) message and a session initiation protocol (SIP) redirection (3XX) message.

57. The system of claim 56 wherein the release message is a SIP redirection message and further comprising a signaling gateway for translating the SIP redirection message into an ISUP REL message.

58. The system of claim 17 wherein using the information identifying the subscriber to determine whether call redirection information exists for the subscriber includes using the information identifying the subscriber to search at least one of a database, a data structure, a table, a memory location, and a data store for call redirection information associated with the subscriber.

59. The system of claim 17 wherein the call redirection information associated with the subscriber comprises at least one of a location routing number, information identifying a network address, information identifying a network, and routing information associated with the subscriber.

60. The system of claim 17 wherein determining whether call redirection information exists for the subscriber includes using at least one of a transaction capabilities application part (TCAP) protocol, an Internet protocol (IP), a signaling connection and control part (SCCP) user adaptation (SUA) protocol, a session initiation protocol (SIP), an extensible markup language (XML) protocol, a hypertext transfer protocol (HTTP), and a simple object access protocol (SOAP) to access the call redirection information associated with the subscriber.

61. The system of claim 17 wherein the release message includes the call redirection information prepended to the information identifying the subscriber.

62. The system of claim 17 wherein the release message contains information indicating the cause of the call redirection.

63. The system of claim 17 comprising, at a source of the call setup signaling message, receiving the release message, and, in response to receiving the release message, releasing the current bearer path and selecting a new bearer path based on the redirection information associated with the subscriber.

64. The system of claim 31 wherein selecting a new bearer path includes sending, from the call setup signaling message, a second call setup signaling message for establishing a call that uses the new bearer path.

65. A computer readable medium having stored thereon computer-executable instructions that when executed by the processor of a computer perform steps comprising:
intercepting a call setup signaling message that is associated with a call using a first circuit-switched bearer path originating at the switching point and that contains information identifying a subscriber;
determining, using the information identifying the subscriber, whether call redirection information exists for the subscriber, wherein the call redirection information comprises one of call offloading information, switching office cutover information, and advanced routing information; and
in response to determining that the call redirection information exists, sending to the source of the call setup signaling message a release message for releasing the first circuit-switched bearer path and selecting a second bearer path based on the call redirection information associated with the subscriber.

66. A computer readable medium having stored thereon computer-executable instructions that when executed by the processor of a computer perform steps comprising:
intercepting a call setup signaling message that is associated with a call in a telecommunications network having a circuit-switched portion and a packet-switched portion and for which a first circuit-switched bearer path has been reserved, the message containing information identifying a subscriber;
determining, using the information identifying the subscriber, whether call redirection information exists for the subscriber; and
in response to determining that the call redirection information exists, sending a release message for releasing the first circuit-switched bearer path and selecting a second bearer path based on the redirection information associated with the subscriber.
